(19) United States
(12) Patent Application Publication
(10) Pub. No.: US 2026/0138387 A1
(43) Pub. Date: May 21, 2026

(54) RECORDING DEVICE

(71) Applicant: SEIKO EPSON CORPORATION, Tokyo (JP)

(72) Inventor: Hiroki AOKI, MATSUMOTO-SHI (JP)

(21) Appl. No.: 19/386,561

(22) Filed: Nov. 12, 2025

(30) Foreign Application Priority Data
Nov. 15, 2024 (JP) 2024-199490

(51) Int. Cl. B41J 29/17; B41J 11/00

(52) U.S. Cl. CPC B41J 29/17; B41J 11/007

(57) ABSTRACT

A recording device 1 includes a first washing unit 50 that includes a first washing section 51 that applies liquid L1b to the outer peripheral surface 25a of the transport belt 25 to perform washing; a second washing unit 60 that is arranged side by side with the first washing unit 50 that includes a second washing section 61 that applies liquid L2a to the outer peripheral surface 25a to perform washing; and a storage tank 54 that is arranged below the first washing unit 50 and the second washing unit 60 and that is configured to store the liquid L1b, wherein an amount of the liquid L2a supplied to the second washing section 61 is smaller than an amount of the liquid L1b supplied to the first washing section 51, the first washing section 51 applies the liquid L1b accumulated in the storage tank 54 to the outer peripheral surface 25a, and the second washing section 61 applies the liquid L2a different from the liquid L1b accumulated in the storage tank 54 to the outer peripheral surface 25a.

The present application is based on, and claims priority from JP Application Serial Number 2024-199490, filed Nov. 15, 2024, the disclosure of which is hereby incorporated by reference herein in its entirety.

### BACKGROUND

### 1. Technical Field

The present disclosure relates to a recording device.

### 2. Related Art

In the related art, various recording devices including a transport belt that includes an outer peripheral surface for supporting a medium and that is capable of transporting the medium by moving the outer peripheral surface, and a recording section that performs recording on the medium that is transported are used. Among these, there is a recording device including a washing section that performs washing by applying liquid to the outer peripheral surface of the transport belt. For example, JP-A-2014-136625 discloses a recording device including a transport belt that transports a medium, a recording head that performs recording on the medium that is transported, and a belt washing device that washes the transport belt.

In a recording device of the related art, such as that disclosed in JP-A-2014-136625, which includes a transport belt that includes an outer peripheral surface for supporting a medium and that is capable of transporting the medium by moving the outer peripheral surface, a recording section that performs recording on the medium that is transported, and a washing section that performs washing by applying liquid to the outer peripheral surface of the transport belt, an amount of liquid used in the washing section is large. However, since liquid used in the washing section is industrial waste, a large amount of the liquid requires a large storage space and increases the cost of processing the liquid. Therefore, it is desirable to reduce an amount of the liquid used.

### SUMMARY

A recording device of the present disclosure for overcoming the above-described

problem includes a transport belt that includes an outer peripheral surface for supporting a medium and that is configured to transport the medium by moving the outer peripheral surface; a recording section that performs recording on the medium that is transported; a first washing unit that includes a first washing section that applies liquid to the outer peripheral surface to perform washing, a first removal section that contacts the outer peripheral surface after washing by the first washing section to remove foreign matter, and a first supply section that supplies liquid to the first washing section; a second washing unit that is arranged side by side with the first washing unit in a movement direction of the outer peripheral surface and that includes a second washing section that applies liquid to the outer peripheral surface to perform washing, a second removal section that contacts the outer peripheral surface after washing by the second washing section to remove foreign matter, and a second supply section that supplies liquid to the second washing section; a storage tank that is arranged below the first washing unit and the second washing unit and that is configured to store liquid; and a discharge section that discharges liquid accumulated in the storage tank, wherein an amount of liquid supplied to the second washing section by the second supply section is smaller than an amount of liquid supplied to the first washing section by the first supply section, the first washing section applies liquid accumulated in the storage tank to the outer peripheral surface, and the second washing section applies liquid different from liquid accumulated in the storage tank to the outer peripheral surface.

### BRIEF DESCRIPTION OF THE DRAWINGS

FIG. 1 is a schematic side view illustrating a recording device according to a first

embodiment of the present disclosure.

FIG. 2 is a schematic side view illustrating a periphery of a washing section of the recording device of FIG. 1.

FIG. 3 is a schematic bottom view illustrating a periphery of the washing section of the recording device of FIG. 1.

FIG. 4 is a schematic bottom view illustrating a periphery of a washing section of a recording device according to a second embodiment of the present disclosure.

FIG. 5 is a schematic bottom view illustrating a periphery of a washing section of a recording device according to a third embodiment of the present disclosure.

FIG. 6 is a schematic bottom view illustrating a periphery of a washing section of a recording device according to a fourth embodiment of the present disclosure.

FIG. 7 is a schematic side view illustrating a periphery of a washing section of a recording device according to a fifth embodiment of the present disclosure.

FIG. 8 is a schematic side view illustrating a periphery of a washing section of a recording device according to a sixth embodiment of the present disclosure.

FIG. 9 is a schematic side view illustrating a periphery of a washing section of a recording device of a reference example.

### DESCRIPTION OF EMBODIMENTS

First, the present disclosure will be schematically described.

A recording device according to a first aspect of the present disclosure for overcoming the above-described problem includes a transport belt that includes an outer peripheral surface for supporting a medium and that is configured to transport the medium by moving the outer peripheral surface; a recording section that performs recording on the medium that is transported; a first washing unit that includes a first washing section that applies liquid to the outer peripheral surface to perform washing, a first removal section that contacts the outer peripheral surface after washing by the first washing section to remove foreign matter, and a first supply section that supplies liquid to the first washing section; a second washing unit that is arranged side by side with the first washing unit in a movement direction of the outer peripheral surface and that includes a second washing section that applies liquid to the outer peripheral surface to perform washing, a second removal section that contacts the outer peripheral surface after washing by the second washing section to remove foreign matter, and a second supply section that supplies liquid to the second washing section; a storage tank that is arranged below the first washing unit and the second washing unit and that is configured to store liquid; and a discharge section that discharges liquid accumulated in the storage tank, wherein an amount of liquid supplied to the second washing section by the second supply section is smaller than an amount of liquid supplied to the first washing section by the first supply section, the first washing section applies liquid accumulated in the storage tank to the outer peripheral surface, and the second washing section applies liquid different from liquid accumulated in the storage tank to the outer peripheral surface.

According to the present aspect, the second washing unit is provided in addition to the first washing unit as the washing section that applies liquid to the outer peripheral surface of the transport belt to perform washing. The first washing section of the first washing unit applies liquid accumulated in the storage tank to the outer peripheral surface, and the second washing section of the second washing unit applies liquid different from liquid accumulated in the storage tank to the outer peripheral surface. With such a configuration, it is possible to reduce a contamination speed of liquid accumulated in the storage tank, and as a result, it is possible to efficiently wash the outer peripheral surface of the transport belt with a small amount of liquid. Therefore, washing can be performed while suppressing an amount of liquid used.

A recording device according to a second aspect of the present disclosure is an aspect according to the first aspect, and the second washing unit is arranged upstream of the first washing unit in the movement direction of the outer peripheral surface, the storage tank includes a first storage tank arranged below the first washing section and the first removal section, and a second storage tank arranged below the second washing section and the second removal section, and the discharge section includes a first discharge section that discharges liquid accumulated in the first storage tank and a second discharge section that discharges liquid accumulated in the second storage tank.

According to the present aspect, the second washing unit is arranged upstream of the first washing unit in the movement direction of the outer peripheral surface, the storage tank includes the first storage tank arranged below the first washing section and the first removal section, and the second storage tank arranged below the second washing section and the second removal section, and the discharge section includes the first discharge section that discharges liquid accumulated in the first storage tank and the second discharge section that discharges liquid accumulated in the second storage tank. That is, the second washing unit is arranged upstream of the first washing unit in the movement direction of the outer peripheral surface, and the storage tanks are separately configured in the first washing unit and the second washing unit. Therefore, after the outer peripheral surface of the transport belt is provisionally washed by the second washing unit using liquid different from liquid accumulated in the storage tank, the outer peripheral surface of the transport belt can be mainly washed by the first washing unit using liquid accumulated in the storage tank, and thus, washing can be performed while particularly suppressing an amount of liquid used.

A recording device according to a third aspect of the present disclosure is an aspect according to the first aspect, and the second washing unit is arranged downstream of the first washing unit in the movement direction of the outer peripheral surface.

According to the present aspect, the second washing unit is arranged downstream of the first washing unit in the movement direction of the outer peripheral surface. Therefore, after the outer peripheral surface of the transport belt is provisionally washed by the first washing unit using liquid accumulated in the storage tank, the outer peripheral surface of the transport belt can be mainly washed by the second washing unit using liquid different from liquid accumulated in the storage tank, and thus, washing can be performed while particularly suppressing an amount of liquid used.

A recording device according to a fourth aspect of the present disclosure is an aspect according to the third aspect, and the storage tank includes a first storage tank arranged below the first washing section and the first removal section, and a second storage tank arranged below the second washing section and the second removal section and the discharge section includes a first discharge section that discharges liquid accumulated in the first storage tank and a second discharge section that discharges liquid accumulated in the second storage tank.

According to the present aspect, the storage tanks are separately configured in the first washing unit and the second washing unit. With such a configuration, it is possible to suppress liquid in the first storage tank and liquid in the second storage tank from being mixed with each other, and it is possible to perform washing while particularly effectively suppressing an amount of liquid used.

A recording device according to a fifth aspect of the present disclosure is an aspect according to the second aspect, and the first washing unit includes a detection section that detects a contamination degree of liquid accumulated in the first storage tank and the first discharge section discharges liquid accumulated in the first storage tank based on detection by the detection section of the contamination degree exceeding a predetermined threshold.

According to the present aspect, the first washing unit includes the detection section that detects a contamination degree of liquid accumulated in the first storage tank, and the first discharge section discharges liquid accumulated in the first storage tank based on detection by the detection section of the contamination degree exceeding a predetermined threshold. With such a configuration, liquid accumulated in the first storage tank can be discharged and replaced at an appropriate timing, and thus washing can be performed while particularly effectively suppressing an amount of liquid used.

A recording device according to a sixth aspect of the present disclosure is an aspect according to the second aspect, and the first washing section is configured to adjust at least one of an amount and a temperature of liquid to be applied to the outer peripheral surface based on at least one of recording information relating to a recording condition and medium information relating to the medium.

According to the present aspect, the first washing section is configured to adjust at least one of an amount and a temperature of liquid to be applied to the outer peripheral surface based on at least one of recording information and medium information. Although a degree of contamination of the outer peripheral surface varies depending on a recording condition, a type of a medium, and the like, by adopting such a configuration, it is possible to appropriately set a washing condition by the first washing section depending on a recording condition, a type of a medium, and the like.

A recording device according to a seventh aspect of the present disclosure is an aspect according to the second aspect, and the first washing unit includes a filtration section that filters liquid discharged from the first discharge section and the first supply section is configured to supply liquid filtered by the filtration section to the first storage tank.

According to the present aspect, the first washing unit includes the filtration section that filters liquid discharged from the first discharge section, and the first supply section is configured to supply liquid filtered by the filtration section to the first storage tank. With such a configuration, it is possible to reuse liquid accumulated in the first storage tank, and it is possible to perform washing while particularly effectively suppressing an amount of liquid used.

A recording device according to an eighth aspect of the present disclosure is an aspect according to any one of the first to seventh aspects, and the second washing section is configured to adjust at least one of an amount and a temperature of liquid to be applied to the outer peripheral surface based on at least one of recording information relating to a recording condition and medium information relating to the medium.

According to the present aspect, the second washing section is configured to adjust at least one of an amount and a temperature of liquid to be applied to the outer peripheral surface based on at least one of recording information and medium information. Although a degree of contamination of the outer peripheral surface varies depending on a recording condition, a type of a medium, and the like, by adopting such a configuration, it is possible to appropriately set a washing condition by the second washing section depending on a recording condition, a type of a medium, and the like.

A recording device according to a ninth aspect of the present disclosure is an aspect according to any one of the first to eighth aspects, and the second washing section applies liquid to an entire area of the outer peripheral surface in a width direction intersecting the movement direction of the outer peripheral surface.

According to the present aspect, the second washing section applies liquid to an entire area in the width direction. With such a configuration, the washing effect by the second washing section can be enhanced.

A recording device according to a tenth aspect of the present disclosure is an aspect according to any one of the first to eighth aspects, and the second removal section is a blade that has a shape inclined with respect to a width direction intersecting the movement direction of the outer peripheral surface and that contacts the outer peripheral surface.

According to the present aspect, the second removal section is a blade that has a shape inclined with respect to the width direction and that contacts the outer peripheral surface. With such a configuration, even when a supply destination of liquid by the second supply section is a narrow region, liquid can be applied to an entire area in the width direction of the outer peripheral surface by the blade. That is, the washing effect of the second washing section can be enhanced with a simple configuration.

### First Embodiment

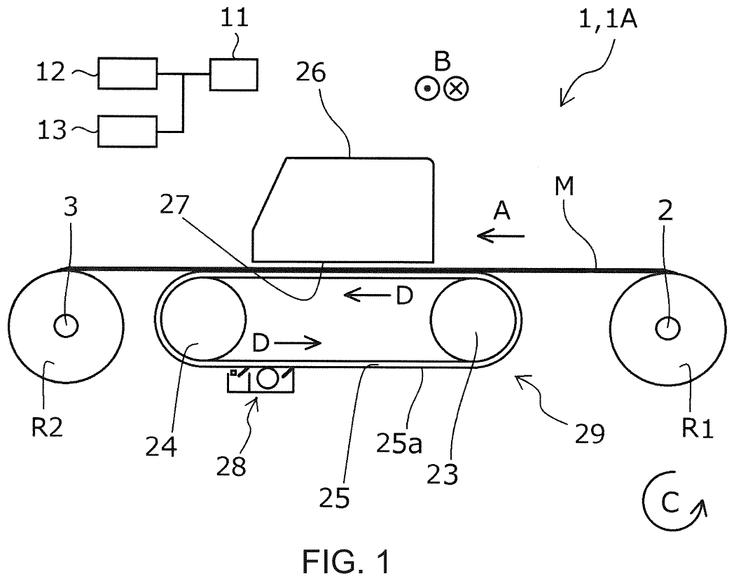

Hereinafter, an embodiment according to the present disclosure will be described with reference to the drawings. First, an outline of a recording device 1A of a first embodiment as an example of a recording device 1 of the present disclosure will be described with reference to FIG. 1. As illustrated in FIG. 1, the recording device 1A of the present embodiment includes a holding section 2 capable of rotatably holding a roll body R1 in which a medium M such as a fabric is wound in a roll shape. The recording device 1A also includes a transport section 29 that transports the medium M, and a head 27 as a recording section that records an image by ejecting ink onto the medium M transported by the transport section 29. The recording device 1A also includes a winding section 3 that can form a roll body R2 by winding the medium M on which recording is performed into a roll shape.

The holding section 2 holds a paper tube that constitutes a rotation shaft of the roll body R1, and is capable of rotating in a rotation direction C to feed the medium M from the roll body R1 to the transport section 29 of the recording device 1A. The holding section 2 may be configured separately from the recording device 1A, but may be a part of a constituent member of the recording device 1A.

The recording device 1A of the present embodiment is an inkjet printer that can form images on the medium M by ejecting ink, which is liquid, in the form of droplets. The recording device 1A includes, as the transport section 29, a driven roller 23 positioned on a upstream side in a transport direction A, which is a transport direction of the medium M, a drive roller 24 positioned on a downstream side in the transport direction A, and a transport belt 25, which is an endless belt stretched between the driven roller 23 and the drive roller 24. Here, the transport belt 25 is an adhesive belt including an outer peripheral surface 25a whose support surface, which is an outer surface, for the medium M is coated with an adhesive.

As illustrated in FIG. 1, in the transport section 29, the medium M is transported while being supported by the transport belt 25 in a state in which the medium M is pasted to the outer peripheral surface 25a. In the recording device 1A of the present embodiment, a medium support region of the transport belt 25 that supports the medium M is an upper region bridged by the driven roller 23 and the drive roller 24. The drive roller 24 is a roller that rotates in the rotation direction C by a drive force of a motor (not illustrated), and the driven roller 23 is a roller that rotates by being driven by the rotation of the transport belt 25 that accompanies the rotation of the drive roller 24.

That is, a movement direction of the transport belt 25 when transporting the medium M is a movement direction D corresponding to the rotation direction C, and a movement direction of the transport belt 25 in the medium support region is the transport direction A. However, it is also possible to rotate the drive roller 24 in a direction opposite to the rotation direction C and move the transport belt 25 in a direction opposite to the movement direction D at the time other than the time of transporting the medium M.

The recording device 1A of the present embodiment includes a carriage 26 that can reciprocate in a width direction B of the transport belt 25, and the head 27 that is attached to the carriage 26. The head 27 is a recording section capable of forming an image by ejecting liquid ink onto the medium M transported in the transport direction A based on record data. The recording device 1A of the present embodiment includes a washing section 28 that washes the transport belt 25 downstream of the head 27 in the movement direction D of the transport belt 25. The detailed configuration of the washing section 28 will be described later.

The recording device 1A of the present embodiment can form an image by ejecting ink from the head 27 onto the medium M that is transported while reciprocating the carriage 26 in the width direction B, which intersects the transport direction A. By providing the carriage 26 with such a configuration, the recording device 1A of the present embodiment can form a desired image on the medium M by repeating transport of the medium M in the transport direction A by a predetermined transport amount and ejection of ink while moving the carriage 26 in the width direction B in a state where the medium M is stopped. However, a configuration of the recording section is not particularly limited. For example, a so-called line head in which nozzles that eject ink are provided over the entire width direction B of the medium M may be used as the recording section.

As described above, the recording device 1A of the embodiment includes the winding section 3. The medium M on which an image is formed by ejecting ink from the head 27 is wound as the roll body R2 by the winding section 3. The winding section 3 holds a paper tube as a rotation shaft for forming the roll body R2, and rotates in the rotation direction C to wind the medium M around the paper tube, thereby forming the roll body R2. The winding section 3 may be configured separately from the recording device 1A, but may be a part of a constituent member of the recording device 1A. A drying device or the like for drying ink ejected onto the medium M may be provided between the winding section 3 and the recording device 1A.

Here, as the medium M, a material to be printed can be desirably used. The material to be printed refers to a fabric, a garment, an other clothing product, and the like that are the target of printing. Fabrics include woven, knitted, and nonwoven fabrics made of natural fibers such as cotton, silk, and wool, synthetic fibers such as nylon, or composite fibers mixed with these fibers. Garments and other clothing products include sewn T-shirts, handkerchiefs, scarves, towels, handbags, bags made of cloth, curtains, sheets, bed covers, and other furniture, as well as fabric before and after cutting, which exists as parts before being sewn together. However, in addition to the above-mentioned material to be printed, special paper for inkjet recording such as plain paper, high-quality paper, and glossy paper can also be used.

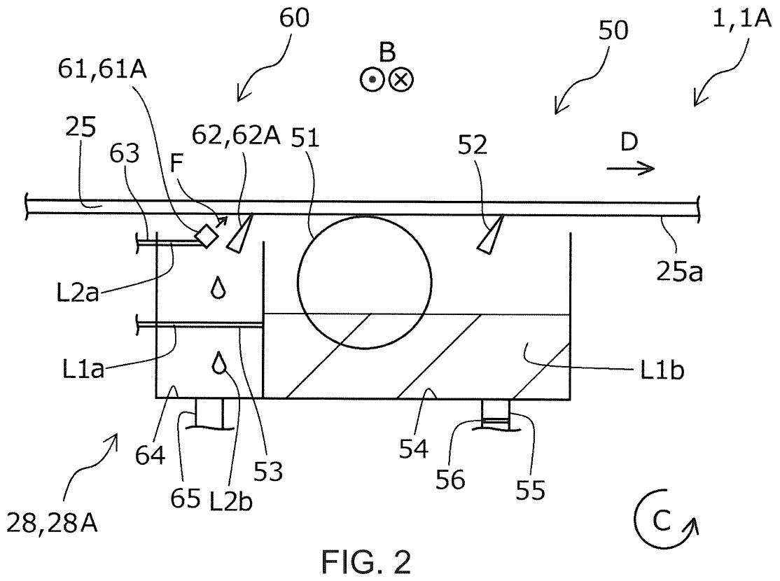

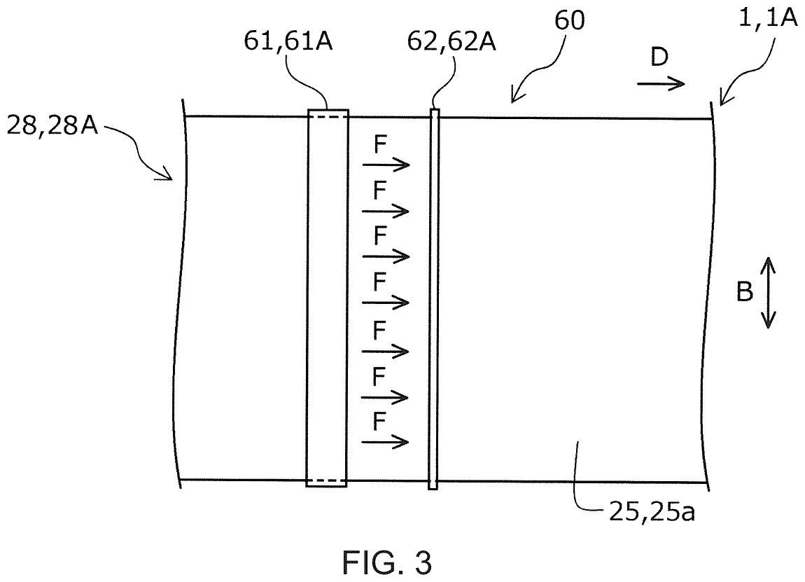

As described above, the recording device 1A of the present embodiment includes the transport belt 25 that includes the outer peripheral surface 25a for supporting the medium M and that is capable of transporting the medium M by moving the outer peripheral surface 25a, the head 27 that performs recording on the medium M transported by the transport belt 25, and the washing section 28 that washes the outer peripheral surface 25a. Therefore, hereinafter, details of the washing section 28A of the present embodiment that is an example of the washing section 28 that is a main part of the recording device 1A of the present embodiment will be described with reference to FIGS. 2 and 3.

As illustrated in FIG. 2, the washing section 28A of the present embodiment includes a first washing unit 50 and a second washing unit 60. The first washing unit 50 includes a supply pipe 53 that supplies washing liquid L1a, which is liquid such as water, for washing the outer peripheral surface 25a, a water tank section 54 that accumulates the washing liquid L1a supplied from the supply pipe 53 as washing liquid L1b together with liquid after washing the outer peripheral surface 25a, and a rotating brush 51 constituting a first washing section that washes the outer peripheral surface 25a while applying the washing liquid L1b accumulated in the water tank section 54 to the outer peripheral surface 25a. Furthermore, the first washing unit 50 includes a wiper 52 as a first removal section that contacts the outer peripheral surface 25a after being washed by the rotating brush 51 to remove foreign matter, and a discharge pipe 55 as a discharge section that can discharge the washing liquid L1b accumulated in the water tank section 54. In the present embodiment, the supply pipe 53 and the water tank section 54 serve as a first supply section that supplies the washing liquid L1b to the rotating brush 51. The water tank section 54 can also be regarded as constituting the first washing section in addition to the rotating brush 51.

Since the washing liquid L1b applied to the outer peripheral surface 25a includes liquid after washing the outer peripheral surface 25a together with the washing liquid L1a supplied from the supply pipe 53, the washing liquid L1b becomes dirty due to ink, fluff derived from the medium M, or the like, with use. Therefore, the washing liquid L1b accumulated in the water tank section 54 is discharged through the discharge pipe 55 depending on a contamination degree, and new washing liquid L1a is supplied to the water tank section 54 through the supply pipe 53. The washing liquid L1a supplied to the water tank section 54 through the supply pipe 53 can be recycled by washing the washing liquid L1b discharged through the discharge pipe 55, for example by filtering the washing liquid L1b through a filtration section 56.

The second washing unit 60 includes a supply pipe 63 that supplies washing liquid L2a, which is liquid for washing the outer peripheral surface 25a, and a spray section 61 (spray section 61A) as a second washing section that washes the outer peripheral surface 25a by forcefully spraying and applying the washing liquid L2a supplied from the supply pipe 63 toward the outer peripheral surface 25a in a spray direction F. Furthermore, the second washing unit 60 includes a water tank section 64 that accumulates liquid that has mixed with ink and the like and become waste liquid when sprayed from the spray section 61A to the outer peripheral surface 25a, a wiper 62 (wiper 62A) as a second removal section that contacts the outer peripheral surface 25a after being washed by the spray section 61A to remove foreign matter, and a discharge pipe 65 as a discharge section that can discharge waste liquid (washing liquid L2b) accumulated in the water tank section 64. Here, in the present embodiment, the washing liquid L2a is water, and the supply pipe 63 serves as a second supply section that supplies the washing liquid L2a to the spray section 61A.

The water tank section 54 as a storage tank capable of storing the washing liquid L1b as liquid and the discharge pipe 55 that discharges the washing liquid L1b accumulated in the water tank section 54 are both arranged below the rotating brush 51, the wiper 52, and the supply pipe 53. Here, the rotating brush 51, the wiper 52, and the supply pipe 53 can be regarded as the first washing unit 50, and the water tank section 54 and the discharge pipe 55 can be regarded as being arranged below the first washing unit 50. Similarly, the water tank section 64 as a storage tank capable of storing waste liquid (washing liquid L2b) derived from the washing liquid L2a as liquid, and the discharge pipe 65 that discharges the washing liquid L2a accumulated in the water tank section 64 are both arranged below the spray section 61A, the wiper 62A, and the supply pipe 63. Here, the spray section 61A, the wiper 62A, and the supply pipe 63 can be regarded as the second washing unit 60, and the water tank section 64 and the discharge pipe 65 can be regarded as being arranged below the second washing unit 60.

In the washing section 28A of the present embodiment, an amount of liquid (washing liquid L2a) supplied to the spray section 61A by the supply pipe 63 is smaller than an amount of liquid (washing liquid L1a) supplied to the water tank section 54 by the supply pipe 53. In the washing section 28A of the present embodiment, the rotating brush 51 applies liquid (washing liquid L1b) accumulated in the water tank section 54 to the outer peripheral surface 25a, and the spray section 61A applies liquid (washing liquid L2a) different from liquid (washing liquid L1b) accumulated in the water tank section 54 to the outer peripheral surface 25a. The washing section 28A of the present embodiment is configured as described above, and thus it is possible to reduce a contamination speed of liquid accumulated in the water tank section 54, and as a result, it is possible to efficiently wash the outer peripheral surface 25a of the transport belt 25 with a small amount of liquid. Therefore, the outer peripheral surface 25a can be washed while suppressing an amount of liquid used.

Here, “an amount of liquid (washing liquid L2a) supplied to the spray section 61A by the supply pipe 63 is smaller than an amount of liquid (washing liquid L1a) supplied to the water tank section 54 by the supply pipe 53” means that, when supply capacity of liquid (washing liquid L2a) by the supply pipe 63 and supply capacity of liquid (washing liquid L1a) by the supply pipe 53 are compared, supply capacity of liquid (washing liquid L1a) by the supply pipe 53 may be higher. Therefore, for example, even in a case where the supply of liquid by the supply pipe 53 is stopped, a case where supply capacity of liquid per short time is higher in the supply pipe 53 than in the supply pipe 63 when the supply of liquid is started is included in the present disclosure. However, it is particularly desirable that a total amount of liquid supplied to the spray section 61A by the supply pipe 63 used in accordance with the use of the recording device 1 is smaller than a total amount of liquid supplied to the water tank section 54 by the supply pipe 53 used in accordance with the use of the recording device 1. This is because a total amount of liquid used for washing the outer peripheral surface 25a of the transport belt 25 can be particularly reduced. With such a configuration, the recording device 1A of the present embodiment can quickly accumulate liquid (washing liquid L1b) in the water tank section 54 by supplying liquid (washing liquid L1a) by the supply pipe 53 while suppressing an amount of liquid (washing liquid L2a) supplied by the supply pipe 63.

Furthermore, in the recording device 1A of the present embodiment, the rotating brush 51 also applies the washing liquid L1b to the outer peripheral surface 25a, and therefore, it can be considered that the rotating brush 51 serves as the first supply section that supplies liquid used for washing the outer peripheral surface 25a. In the recording device 1A of the present embodiment, an amount of liquid (washing liquid L2a) supplied to the spray section 61A by the supply pipe 63 is smaller than an amount of liquid (washing liquid L1b) applied to the outer peripheral surface 25a by the rotating brush 51 as the first supply section. With such a configuration, the outer peripheral surface 25a can be washed while suppressing an amount of liquid used. That is, the present disclosure may satisfy either one of “a configuration in which an amount of liquid supplied to the spray section 61A by the supply pipe 63 as the second supply section is smaller than an amount of liquid supplied to the water tank section 54 by the supply pipe 53 as the first supply section” and “a configuration in which an amount of liquid supplied to the spray section 61A by the supply pipe 63 as the second supply section is smaller than an amount of liquid applied to the outer peripheral surface 25a by the rotating brush 51 as the first supply section”. When either one of these conditions is satisfied, a contamination speed of liquid (washing liquid L1b) accumulated in the water tank section 54 can be reduced.

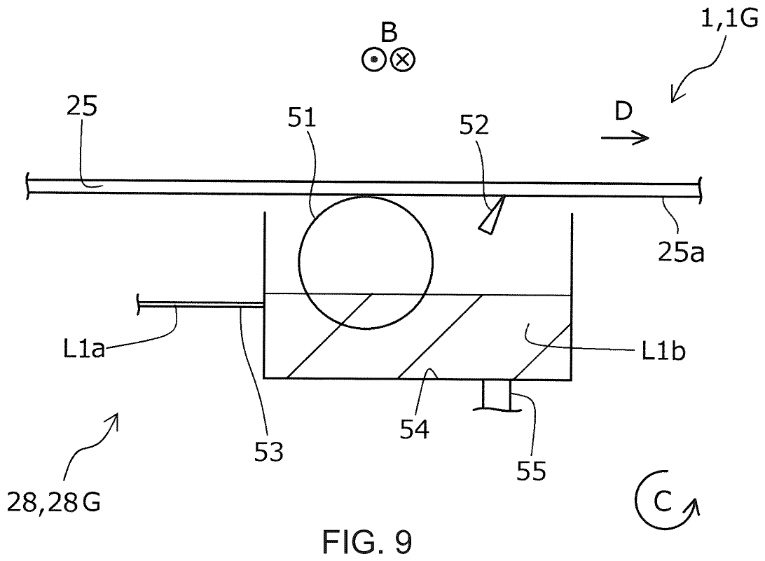

On the other hand, in a recording device 1G of a reference example that does not include a washing unit corresponding to the second washing unit 60 as illustrated in FIG. 9, since the washing section 28G is configured to perform washing with only one washing unit using liquid (washing liquid L1b) that is accumulated in the water tank section 54, a contamination speed of liquid (washing liquid L1b) that is accumulated in the water tank section 54 is fast. Therefore, liquid (washing liquid L1b) accumulated in the water tank section 54 must be replaced frequently. For example, when a recording operation is performed under the same conditions, a contamination speed of liquid (washing liquid L1b) accumulated in the water tank section 54 can be reduced by approximately 35% in the recording device 1A of the present embodiment compared to the recording device 1G of the reference example.

As illustrated in FIG. 2, in the washing section 28A of the present embodiment, the second washing unit 60 is arranged upstream of the first washing unit 50 in the movement direction D of the outer peripheral surface 25a. The washing section 28A of the present embodiment includes, as the storage tank, a water tank section 54 as a first storage tank arranged below the rotating brush 51 and the wiper 52, and a water tank section 64 as a second storage tank arranged below the spray section 61A and the wiper 62A. The washing section 28A of the present embodiment includes, as the discharge section, the discharge pipe 55 as a first discharge section that discharges liquid (washing liquid L1b) accumulated in the water tank section 54, and the discharge pipe 65 as a second discharge section that discharges liquid (washing liquid L2b) accumulated in the water tank section 64.

That is, in the washing section 28A of the present embodiment, the second washing unit 60 is arranged upstream of the first washing unit 50 in the movement direction D of the outer peripheral surface 25a, and the storage tanks are separately configured in the first washing unit 50 and the second washing unit 60. Therefore, the washing section 28A of the present embodiment can perform main washing of the outer peripheral surface 25a of the transport belt 25 by the first washing unit 50 using liquid (washing liquid L1b) accumulated in the water tank section 54 after the outer peripheral surface 25a of the transport belt 25 is subjected to the provisional washing by the second washing unit 60 using liquid (washing liquid L2a) different from the liquid (washing liquid L1b) accumulated in the water tank section 54. Therefore, the outer peripheral surface 25a can be washed while particularly suppressing an amount of liquid used.

As illustrated in FIG. 1, the recording device 1A of the present embodiment includes a control sectoin 11 including a storage section such as a ROM and a RAM and a CPU, and an operation panel 12 capable of receiving an instruction from a user. Further, the recording device 1A of the present embodiment includes a detection section 13 that detects a contamination degree of liquid (washing liquid L1b) accumulated in the water tank section 54 in the first washing unit 50. The discharge pipe 55 is configured to discharge liquid (washing liquid L1b) accumulated in the water tank section 54 under the control of the control sectoin 11 when the detection section 13 detects that the contamination degree exceeds a predetermined threshold. Since the recording device 1A of the present embodiment includes such a configuration, liquid (washing liquid L1b) accumulated in the water tank section 54 can be discharged and replaced at an appropriate timing, so that the outer peripheral surface 25a can be washed while particularly effectively suppressing an amount of liquid used. In the present embodiment, a contamination degree of liquid accumulated in the water tank section 54 is detected by, for example, measuring color and calculating the concentration of impurities contained in the liquid, but a method of detecting the contamination degree is not particularly limited.

As described above, the recording device 1A of the present embodiment can receive an instruction from a user via the operation panel 12. Here, the water tank section 54 constituting the first washing section is configured to be capable of executing at least one of adjusting an amount of liquid applied to the outer peripheral surface 25a by adjusting a contact volume between liquid (washing liquid L1b) accumulated in the water tank section 54 and the rotating brush 51, and adjusting the temperature of liquid (washing liquid L1b) accumulated in the water tank section 54 using a heater (not illustrated), based on at least one of recording information relating to a recording condition and medium information relating to the medium M as an instruction from a user. A degree of contamination of the outer peripheral surface 25a varies depending on a recording condition, a type of the medium M, and the like, but the recording device 1A of the present embodiment includes such a configuration, and thus it is possible to appropriately set a washing condition by the first washing section depending on a recording condition, a type of the medium M, and the like.

As illustrated in FIG. 2, the first washing unit 50 of the present embodiment includes the filtration section 56 that filters liquid (washing liquid L1b) discharged from the discharge pipe 55. The supply pipe 53 is configured to be able to supply liquid filtered by the filtration section 56 to the water tank section 54 again. The recording device 1A of the present embodiment includes such a configuration, and thus it is possible to reuse liquid accumulated in the water tank section 54, and it is possible to wash the outer peripheral surface 25a while particularly effectively suppressing an amount of liquid used.

The spray section 61A of the present embodiment is configured to be able to adjust at least one of an amount and the temperature of liquid (washing liquid L2a) applied to the outer peripheral surface 25a by an amount adjustment section (not illustrated), a heater (not illustrated), or the like based on at least one of recording information relating to a recording condition and medium information relating to the medium M. A degree of contamination of the outer peripheral surface 25a varies depending on a recording condition, a type of the medium M, and the like, but the recording device 1A of the present embodiment includes such a configuration, and thus it is possible to appropriately set a washing condition by the spray section 61A depending on a recording condition, a type of the medium M, and the like.

Here, as illustrated in FIG. 3, the washing section 28A of the present embodiment is configured such that the spray section 61A can spray liquid (washing liquid L2a) to the outer peripheral surface 25a over the entire area in the width direction B. The wiper 62A is provided over the entire area of the outer peripheral surface 25a along the width direction B perpendicular to the movement direction D. In this manner, the washing effect by the spray section 61A can be enhanced by adopting a configuration in which the spray section 61A can apply liquid (washing liquid L2a) to the entire area in the width direction B intersecting the movement direction D of the outer peripheral surface 25a.

### Second Embodiment

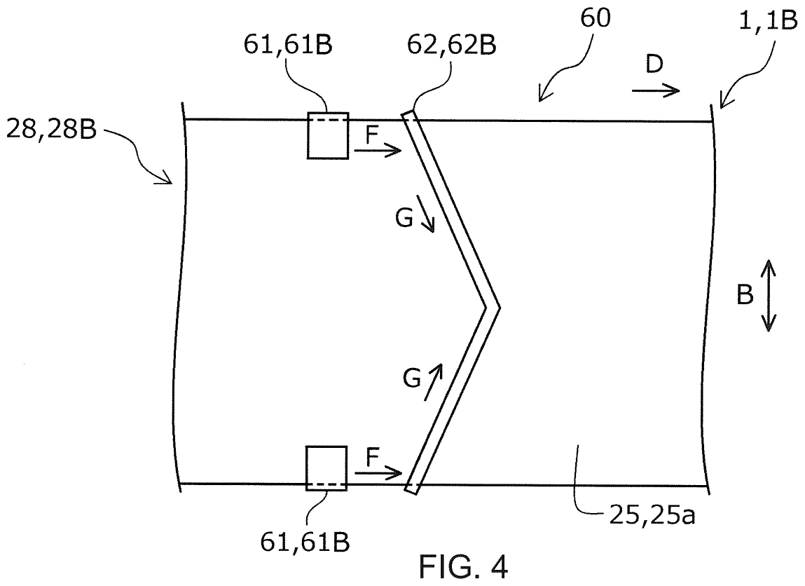

Next, a recording device 1B of a second embodiment will be described with reference to FIG. 4. FIG. 4 is a diagram corresponding to FIG. 3 in the recording device 1A of the first embodiment. In FIG. 4, constituent members common to those of the first embodiment are denoted by the same reference symbols, and detailed description thereof will be omitted. Here, the recording device 1B of the present embodiment includes the same configuration as the recording device 1A of the first embodiment except for the configuration of the washing section 28 (washing section 28B) described below. For this reason, the recording device 1B of the present embodiment has the same features as those of the recording device 1A of the first embodiment except for the parts described below.

As illustrated in FIG. 4, the recording device 1B of the present embodiment includes spray sections 61 (spray sections 61B) as the second washing section that sprays and applies the washing liquid L2a at positions facing both end sections of the outer peripheral surface 25a in the width direction B. The wiper 62 (wiper 62B) is provided in an arrangement in which both end sections of the outer peripheral surface 25a in the width direction B are positioned on an upstream side in the movement direction D and a central section of the outer peripheral surface 25a in the width direction B is positioned on a downstream side in the movement direction D. The washing liquid L2a sprayed to both end sections of the outer peripheral surface 25a in the width direction B flows in a direction G along the wiper 62B in accordance with the movement of the outer peripheral surface 25a in the movement direction D, and reaches the central section of the outer peripheral surface 25a in the width direction B.

From another viewpoint, in the recording device 1B of the present embodiment, the wiper 62B as the second removal section is a blade that has a shape inclined with respect to the width direction B intersecting the movement direction D of the outer peripheral surface 25a that contacts with the outer peripheral surface 25a. By configuring the second removal section in this manner, even when a supply destination of liquid (washing liquid L2a) by the supply pipe 63 as the second supply section is a narrow region, liquid can be applied to the entire area in the width direction B of the outer peripheral surface 25a by the wiper 62B that is the blade. That is, it is possible to enhance the washing effect by the spray section 61B as the second washing section with a simple configuration.

### Third Embodiment

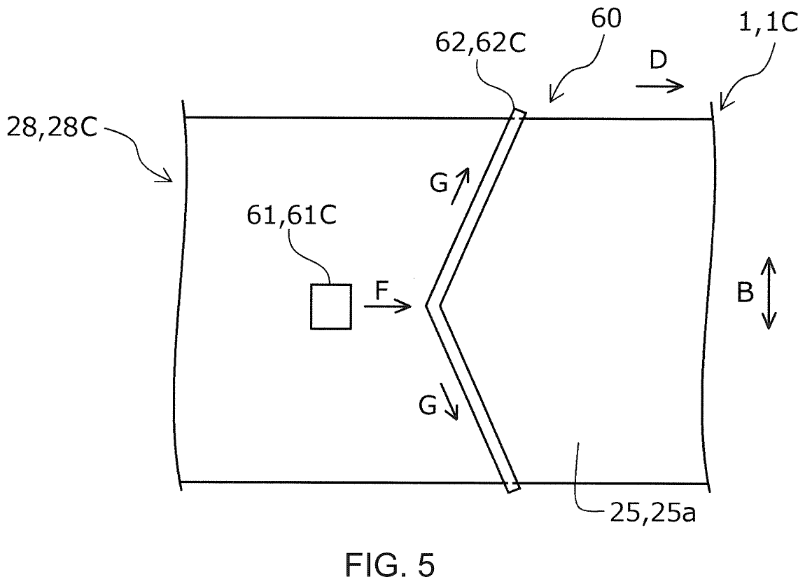

Next, a recording device 1C of a third embodiment will be described with reference to FIG. 5. FIG. 5 is a diagram corresponding to FIG. 3 in the recording device 1A of the first embodiment. In FIG. 5, constituent members common to those of the first embodiment are denoted by the same reference symbols, and detailed description thereof will be omitted. Here, the recording device 1C of the present embodiment includes the same configuration as the recording device 1A of the first embodiment except for the configuration of the washing section 28 (washing section 28C) described below. For this reason, the recording device 1C of the present embodiment has the same features as those of the recording device 1A of the first embodiment except for the parts described below.

As illustrated in FIG. 5, the recording device 1C of the present embodiment includes the spray section 61 (spray section 61C) as the second washing section that sprays and applies the washing liquid L2a at a position facing the central section of the outer peripheral surface 25a in the width direction B. The wiper 62 (wiper 62C) is provided in an arrangement in which the central section of the outer peripheral surface 25a in the width direction B is positioned on an upstream side in the movement direction D and both end sections of the outer peripheral surface 25a in the width direction B are positioned on a downstream side in the movement direction D. The washing liquid L2a sprayed to the central section of the outer peripheral surface 25a in the width direction B flows in the direction G along the wiper 62C in accordance with the movement of the outer peripheral surface 25a in the movement direction D, and reaches both end sections of the outer peripheral surface 25a in the width direction B.

From another viewpoint, in the recording device 1C of the present embodiment, the wiper 62C as the second removal section is a blade that has a shape inclined with respect to the width direction B intersecting the movement direction D of the outer peripheral surface 25a and contacts with the outer peripheral surface 25a. By configuring the second removal section in this manner, even when a supply destination of liquid (washing liquid L2a) by the supply pipe 63 as the second supply section is a narrow region, liquid can be applied to the entire area in the width direction B of the outer peripheral surface 25a by the wiper 62C that is the blade. That is, it is possible to enhance the washing effect by the spray section 61C as the second washing section with a simple configuration.

### Fourth Embodiment

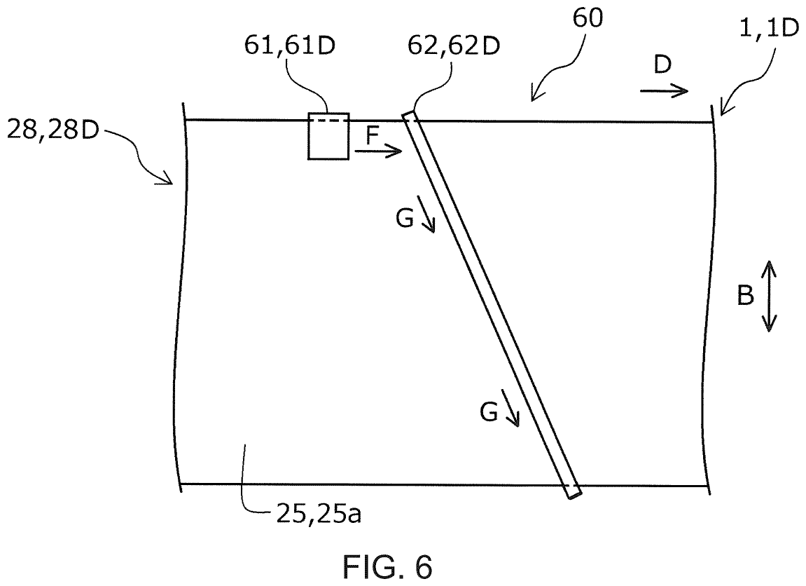

Next, a recording device 1D of a fourth embodiment will be described with reference to FIG. 6. FIG. 6 is a diagram corresponding to FIG. 3 in the recording device 1A of the first embodiment. In FIG. 6, constituent members common to those of the first embodiment are denoted by the same reference symbols, and detailed description thereof will be omitted. Here, the recording device 1D of the present embodiment includes the same configuration as the recording device 1A of the first embodiment except for the configuration of the washing section 28 (washing section 28D) described below. For this reason, the recording device 1D of the present embodiment has the same features as those of the recording device 1A of the first embodiment except for the parts described below.

As illustrated in FIG. 6, the recording device 1D of the present embodiment includes the spray section 61 (spray section 61D) as the second washing section that sprays and applies the washing liquid L2a at a position facing one end section of the outer peripheral surface 25a in the width direction B. The wiper 62 (wiper 62D) is provided in an arrangement in which one end section of the outer peripheral surface 25a in the width direction B is positioned on an upstream side in the movement direction D and an other end section of the outer peripheral surface 25a in the width direction B is positioned on a downstream side in the movement direction D. The washing liquid L2a sprayed to one end section of the outer peripheral surface 25a in the width direction B flows in the direction G along the wiper 62D in accordance with the movement of the outer peripheral surface 25a in the movement direction D, and reaches an other end section of the outer peripheral surface 25a in the width direction B.

From another viewpoint, in the recording device 1D of the present embodiment, the wiper 62D as the second removal section is a blade that has a shape inclined with respect to the width direction B intersecting the movement direction D of the outer peripheral surface 25a and contacts with the outer peripheral surface 25a. By configuring the second removal section in this manner, even when a supply destination of liquid (washing liquid L2a) by the supply pipe 63 as the second supply section is a narrow region, liquid can be applied to the entire area in the width direction B of the outer peripheral surface 25a by the wiper 62D that is the blade. That is, it is possible to enhance the washing effect by the spray section 61D as the second washing section with a simple configuration.

### Fifth Embodiment

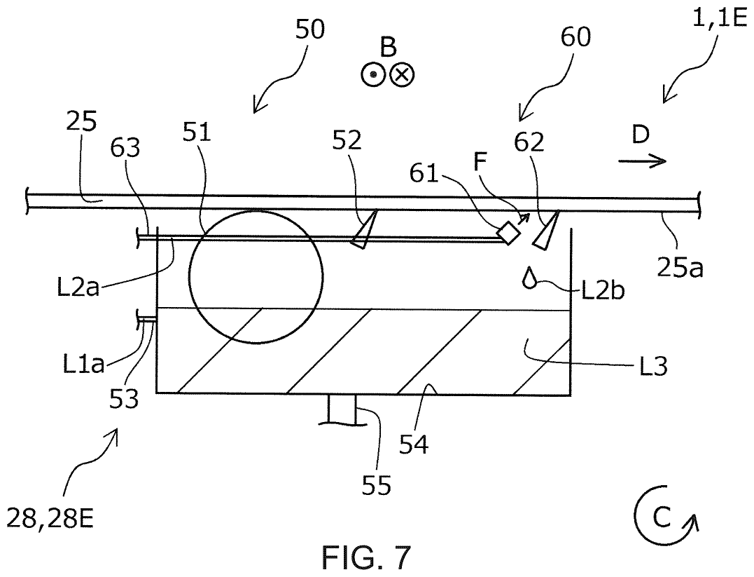

Next, a recording device 1E of a fifth embodiment will be described with reference to FIG. 7. FIG. 7 is a diagram corresponding to FIG. 2 in the recording device 1A of the first embodiment. In FIG. 7, constituent members common to those of the first embodiment are denoted by the same reference symbols, and detailed description thereof will be omitted. Here, the recording device 1E of the present embodiment includes the same configuration as the recording device 1A of the first embodiment except for the configuration of the washing section 28 (washing section 28E) described below. For this reason, the recording device 1E of the present embodiment has the same features as those of the recording device 1A of the first embodiment except for the parts described below.

As described above, in the recording device 1A of the first embodiment, the second washing unit 60 is arranged upstream of the first washing unit 50 in the movement direction D of the outer peripheral surface 25a. With such a configuration, the second washing unit 60 provisionally washes the outer peripheral surface 25a, and the first washing unit 50 mainly washes the outer peripheral surface 25a.

On the other hand, as illustrated in FIG. 7, in the recording device 1E of the present embodiment, the second washing unit 60 is arranged downstream of the first washing unit 50 in the movement direction D of the outer peripheral surface 25a. In the washing section 28E of the present embodiment, liquid (washing liquid L2b) used for washing in the second washing unit 60 is also accumulated in the water tank section 54, and liquid accumulated in the water tank section 54 is washing liquid L3 that is mixed liquid of liquid used for washing in the first washing unit 50 and liquid used for washing in the second washing unit 60.

With such a configuration, the recording device 1E of the present embodiment can provisionally wash the outer peripheral surface 25a of the transport belt 25 by the first washing unit 50 using liquid (washing liquid L3) accumulated in the water tank section 54, and then can mainly wash the outer peripheral surface 25a of the transport belt 25 by the second washing unit 60 using liquid (washing liquid L2a) different from the liquid (washing liquid L3) accumulated in the water tank section 54, and can wash the outer peripheral surface 25a while particularly suppressing an amount of liquid used. 25a This is because the liquid (washing liquid L3) used for provisional washing in the first washing unit 50 is not used for main washing, and thus the washing liquid L3 can be used without any problem even if the washing liquid L3 is contaminated to some extent, and the cycle of replacement of liquid accumulated in the water tank section 54 can be extended. For example, in the recording device 1A of the first embodiment, when the detection section 13 detects that liquid accumulated in the water tank section 54 contains 10% or more of impurities, the replacement is prompted on the operation panel 12, but in the recording device 1E of the present embodiment, even when the detection section 13 detects that liquid accumulated in the water tank section 54 contains 10% or more of impurities, the replacement is not prompted and the use can be continued.

### Sixth Embodiment

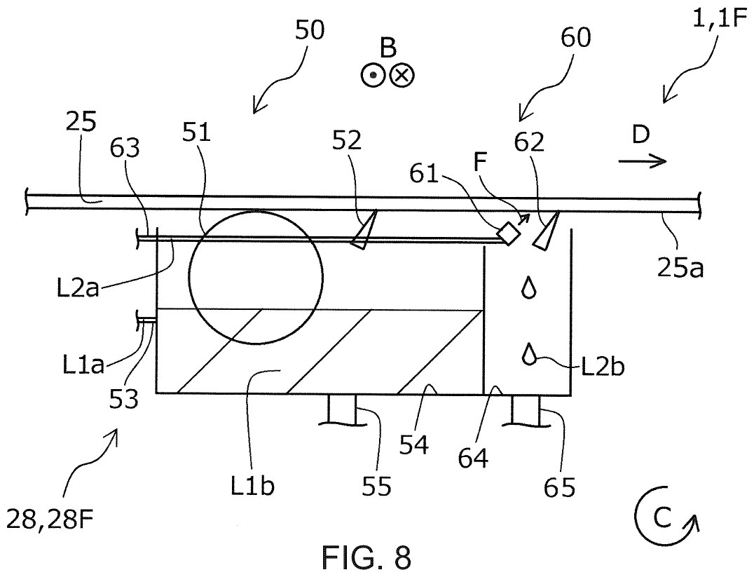

Next, a recording device 1F of a sixth embodiment will be described with reference to FIG. 8. FIG. 8 is a diagram corresponding to FIG. 2 in the recording device 1A of the first embodiment. In FIG. 8, constituent members common to those of the first embodiment are denoted by the same reference symbols, and detailed description thereof will be omitted. Here, the recording device 1F of the present embodiment includes the same configuration as the recording device 1A of the first embodiment except for the configuration of the washing section 28 (washing section 28F) described below. For this reason, the recording device 1F of the present embodiment has the same features as those of the recording device 1A of the first embodiment except for the parts described below.

As illustrated in FIG. 8, in the recording device 1F of the present embodiment, the second washing unit 60 is arranged downstream of the first washing unit 50 in the movement direction D of the outer peripheral surface 25a, similarly to the recording device 1E of the fifth embodiment. Therefore, the recording device 1F of the present embodiment can provisionally wash the outer peripheral surface 25a of the transport belt 25 by the first washing unit 50 using liquid (washing liquid L1b) accumulated in the water tank section 54, and then can mainly wash the outer peripheral surface 25a of the transport belt 25 by the second washing unit 60 using liquid (washing liquid L2a) different from the liquid (washing liquid L1b) accumulated in the water tank section 54, and can wash the outer peripheral surface 25a while particularly suppressing an amount of liquid used. This is because, as in the recording device 1E of the fifth embodiment, the liquid (washing liquid L1b) used for provisional washing in the first washing unit 50 is not used for main washing, and thus, even if the washing liquid L1b is contaminated to some extent, the washing liquid L1b can be used without any problem, and thus, the replacement cycle can be lengthened.

Further, as illustrated in FIG. 8, the recording device 1F of the present embodiment includes, as the storage tank, the water tank section 54 as the first storage tank arranged below the rotating brush 51 and the wiper 52, and the water tank section 64 as the second storage tank arranged below the spray section 61 and the wiper 62. The recording device 1F of the present embodiment includes, as the discharge section, the discharge pipe 55 as the first discharge section that discharges liquid (washing liquid L1b) accumulated in the water tank section 54, and the discharge pipe 65 as the second discharge section that discharges liquid (washing liquid L2b) accumulated in the water tank section 64. By configuring the recording device 1F of the present embodiment in this manner, it is possible to suppress mixing of liquid (washing liquid L1b) in the water tank section 54 and liquid (washing liquid L2b) in the water tank section 64, and it is possible to wash the outer peripheral surface 25a while particularly effectively suppressing an amount of liquid used.

Note that the present disclosure is not limited to the above-described embodiments, and various modifications can be made within the scope of the disclosure described in the claims, and it goes without saying that they are also included in the scope of the present disclosure.

What is claimed is:

1. A recording device comprising:
a transport belt that includes an outer peripheral surface for supporting a medium and that is configured to transport the medium by moving the outer peripheral surface;
a recording section that performs recording on the medium that is transported;
a first washing unit that includes a first washing section that applies liquid to the outer peripheral surface to perform washing, a first removal section that contacts the outer peripheral surface after washing by the first washing section to remove foreign matter, and a first supply section that supplies liquid to the first washing section;
a second washing unit that is arranged side by side with the first washing unit in a movement direction of the outer peripheral surface and that includes a second washing section that applies liquid to the outer peripheral surface to perform washing, a second removal section that contacts the outer peripheral surface after washing by the second washing section to remove foreign matter, and a second supply section that supplies liquid to the second washing section;
a storage tank that is arranged below the first washing unit and the second washing unit and that is configured to store liquid; and
a discharge section that discharges liquid accumulated in the storage tank, wherein
an amount of liquid supplied to the second washing section by the second supply section is smaller than an amount of liquid supplied to the first washing section by the first supply section,
the first washing section applies liquid accumulated in the storage tank to the outer peripheral surface, and
the second washing section applies liquid different from liquid accumulated in the storage tank to the outer peripheral surface.

2. The recording device according to claim 1, wherein
the second washing unit is arranged upstream of the first washing unit in the movement direction of the outer peripheral surface,
the storage tank includes a first storage tank arranged below the first washing section and the first removal section, and a second storage tank arranged below the second washing section and the second removal section, and
the discharge section includes a first discharge section that discharges liquid accumulated in the first storage tank and a second discharge section that discharges liquid accumulated in the second storage tank.

3. The recording device according to claim 1, wherein
the second washing unit is arranged downstream of the first washing unit in the movement direction of the outer peripheral surface.

4. The recording device according to claim 3, wherein
the storage tank includes a first storage tank arranged below the first washing section and the first removal section, and a second storage tank arranged below the second washing section and the second removal section and
the discharge section includes a first discharge section that discharges liquid accumulated in the first storage tank and a second discharge section that discharges liquid accumulated in the second storage tank.

5. The recording device according to claim 2, wherein
the first washing unit includes a detection section that detects a contamination degree of liquid accumulated in the first storage tank and
the first discharge section discharges liquid accumulated in the first storage tank based on detection by the detection section of the contamination degree exceeding a predetermined threshold.

6. The recording device according to claim 2, wherein
the first washing section is configured to adjust at least one of an amount and a temperature of liquid to be applied to the outer peripheral surface based on at least one of recording information relating to a recording condition and medium information relating to the medium.

7. The recording device according to claim 2, wherein
the first washing unit includes a filtration section that filters liquid discharged from the first discharge section and
the first supply section is configured to supply liquid filtered by the filtration section to the first storage tank.

8. The recording device according to claim 1, wherein
the second washing section is configured to adjust at least one of an amount and a temperature of liquid to be applied to the outer peripheral surface based on at least one of recording information relating to a recording condition and medium information relating to the medium.

9. The recording device according to claim 1, wherein
the second washing section applies liquid to an entire area of the outer peripheral surface in a width direction intersecting the movement direction of the outer peripheral surface.

10. The recording device according to claim 1, wherein
the second removal section is a blade that has a shape inclined with respect to a width direction intersecting the movement direction of the outer peripheral surface and that contacts the outer peripheral surface.
